(19) United States
(12) Patent Application Publication
(10) Pub. No.: US 2018/0106544 A1
(43) Pub. Date: Apr. 19, 2018

(54) Portable Collapsible Food Dehydrator

(71) Applicant: Peter Chung-Yuan Chang, San Diego, CA (US)

(72) Inventor: Peter Chung-Yuan Chang, San Diego, CA (US)

(21) Appl. No.: 15/785,224

(22) Filed: Oct. 16, 2017

Related U.S. Application Data
(60) Provisional application No. 62/408,607, filed on Oct. 14, 2016.

(51) Int. Cl. F26B 25/06; F26B 9/06; A23L 3/40

(52) U.S. Cl. CPC F26B 25/066; A23V 2002/00; A23L 3/40; F26B 9/066

(57) ABSTRACT

A collapsible food dehydrator having a cabinet formed of a pair of sidewalls removably engaged using fasteners with a top wall, a bottom wall, and a fan housing. The fasteners impart a tension to the removable engagement to strengthen the cabinet. Shelves are slidably engaged with a plurality of pairs of tracks removably engaged on opposing sides of an interior cavity.

This application claims priority to U.S. Provisional Patent Application Ser. No. 62/408,607, filed on Oct. 14, 2016, which is incorporated herein in its entirety by this reference thereto.

### BACKGROUND OF THE INVENTION

### 1. Field of the Invention

The present invention relates generally to food preparation and preservation. More particularly, the disclosed device relates to a portable food dehydrator which is compact when assembled, but which is also easily disassembled and stored in a compact stacked configuration for transport and storage in-between uses.

### 2. Prior Art

The ability to preserve food, through the task of drying or dehydration, has been known since ancient times. In earlier times, drying or dehydrating food was conventionally accomplished by positioning a chosen meat, fruit, or vegetable, within an open container. Thereafter, the food within the container was subjected to sunlight for a term required to dehydrate the chosen food. Prior to electricity, such a task could take days to accomplish.

Subsequent to the arrival of electricity in homes and businesses, food dehydrators have been developed for use in the home as well as in industry which employ powered movement of air through the housing containing the foodstuff to dry the food which is placed on racks. Such is accomplished generally by the employment of a fan to either pull or push air through a housing and around the food within.

However, a significant problem exists with conventional food dehydrators which has limited the sale and use in homes and businesses. In conventional dehydrators, the cabinet is configured to allow air flow around and between the food within, making conventional food dehydrators are generally large in size.

In homes this can be a significant issue to inhibit purchase and use, because most homes have very limited counter space in kitchens or other rooms where such a dehydrator might be employed in order to limit dust and pathogens in the surrounding air from contacting the food. Should the large device be used on patios or in garages due to their large size, the air supply is less regulated than within the home, and subject to such problems with dust, germs, bugs, and other issues from the air supply.

While such might not be the case with businesses who may have clean rooms and the like, a significant issue for both homes and businesses with dehydrators, is storage after use. Because dehydrators are filled with racks holding food during use, and must, as noted, have good airflow, when they are not being used, conventional dehydrators occupy a significant amount of space due to the large volume inside required. Further, being bulky, such dehydrators are hard to transport should use at another venue or home be desired, and occupy significant space when not in use and stored. Consequently, the use of dehydrators in homes and small businesses, where food can be dried and stored for future use, or in emergencies, is inhibited by their large size, uneasy transport, and overly large occupancy of valuable storage space.

The device herein provides a food dehydrator which is employable in homes and easily transported and stored. The disclosed device herein provides powered airflow and has a cabinet with sufficient interior volume to provide air pathways to effectively and quickly dehydrate food while in an assembled configuration. While being large enough to provide food drying functions, the device herein is collapsible and made easy to transport and compact for storage to encourage use in homes and in multiple locations due to this easy transport. Still further, the device herein while being easily collapsible, is also easily assembled from components which form a spring tensioned cabinet which is sturdy and thereby allows users to store, assemble, and re-store or transport the device with ease.

It should be noted, the foregoing examples of related art and limitations related therewith are intended to be illustrative and not exclusive, and they do not imply any limitations on the device and system described and claimed herein. Various limitations of the related art in dehydrators are already known or will become apparent to those skilled in the art upon a reading and understanding of the specification below and the accompanying drawings.

An object of the present invention is the provision of a food dehydrator which has a cabinet with sufficient interior volume to provide multiple shelves for food as well as efficient air pathways through the cabinet to dry the food.

It is another object of the invention to provide such a food dehydrator, which while having significant interior volume in the cabinet, is also collapsible to a small size and volume rendering it easily transported and stored in small spaces.

It is yet another object of this invention to provide such a dehydrator with an assembled and collapsed configuration, which is easily assembled and disassembled, yet is engaged with tensioned components to render it especially sturdy while in the assembled configuration during use.

Further objectives of the disclosed invention herein will be brought out in the following parts of the specification wherein the summary and detailed description of the invention are for the purpose of fully disclosing the invention without placing limitations thereon.

### SUMMARY OF THE INVENTION

The present invention provides a solution to the noted shortcomings in the art with regard to food dehydrators sized for home and small business use. The dehydrator device herein, features a cabinet having a fan and defined air pathways through the cabinet. The interior of the cabinet has a plurality of opposing tracks which are easily engaged to opposing first and second sidewalls of the cabinet. The opposing removably engageable tracks are configured in their positioning to hold racks therebetween, in a spaced positioning within the interior cavity formed within the top, bottom, sidewalls, and rear wall of the formed cabinet.

The cabinet is formed wherein a fan housing is engaged and functions as the rear wall of the cabinet and thus provides maximized airflow through air pathways formed in-between the spaced shelves. A front wall is engageable during use to close in the cabinet. The front wall so engaged has a plurality of air inlets positioned in spaced horizontal rows. These air inlets are positioned with the front wall engaged to the cabinet to direct incoming air, in-between each of the shelves which hold food while they are slidably engaged upon the tracks.

The positioning of the fan housing, as the rear wall of the housing, places the fan directly in line with the inlets formed in the front wall of the housing. This maximizes the air pulled through the inlets and along the formed air pathways between the racks, before exhausting the air through the exhaust of the fan housing.

With respect to the above description, before explaining at least one preferred embodiment of the herein disclosed belt engageable fishing rod holder in detail, it is to be understood that the invention is not limited in its application to the details of construction and to the arrangement in the following description or illustrated in the drawings. The food dehydrator herein described is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for the designing of other food dehydrators and for carrying out the several purposes of the present disclosed system. It is important, therefore, that the claims herein be regarded as including such equivalent construction and methodology, insofar as they do not depart from the spirit and scope of the present invention.

### BRIEF DESCRIPTION OF DRAWING FIGURES

The accompanying drawings, which are incorporated herein and form a part of the specification, illustrate some, but not the only or exclusive examples of embodiments and/or features of the invention. It is intended that the embodiments and figures disclosed herein are to be considered illustrative rather than limiting.

In the drawings:

FIG. 1 is a perspective view of the portable collapsible food dehydrator herein, in an assembled configuration shown with the sidewalls and fan housing engaged with tensional fasteners and showing the front wall having air passages therein attached.

FIG. 2 is a perspective view of components of the food dehydrator herein, and showing the bottom wall which is hinged in engagement to a first sidewall, and also showing the engageable shelf tracks, hinge and tension-imparting fasteners, used for engagement of the components forming the food dehydrator.

FIG. 3 depicts a step in assembly of the food dehydrator herein, subsequent to the rotation of the first sidewall upward in FIG. 2, wherein the second opposing sidewall is engaged with tensional fasteners and tracks for the racks are ready for engagement with slots in both sidewalls.

FIG. 4 depicts the components of the food dehydrator device herein during assembly wherein a top wall may be engaged with both sidewalls by tensioning fasteners, and showing the tabs of each track engaged with slots in the sidewalls, and ready for insertion of food racks.

FIG. 5 depicts the fan housing being engaged as a rear wall of the housing, using the tensional fasteners shown in FIG. 6.

FIG. 6 depicts the housing with the fan housing engaged with the cabinet of the device herein, formed by the sidewalls, top wall and bottom wall operatively engaged with tensional fasteners.

FIG. 7 is a perspective view of the device as in FIG. 6, showing the front wall which is engageable with mating fasteners formed by the top wall and bottom wall of the cabinet, and showing air passages in registered positioning to direct air through flowpaths in-between each rack shown mounted in sidewall-engaged tracks.

FIG. 8, shows the disassembled mode of the food dehydrator herein, and showing that the components are stackable to a compact configuration for storage and transport.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms referring to the device or depictions as such may be oriented, are describing it such as it appears in the drawings and are used for convenience only. Such terms of direction and location are not intended to be limiting or to imply that the device herein has to be used or positioned in any particular orientation.

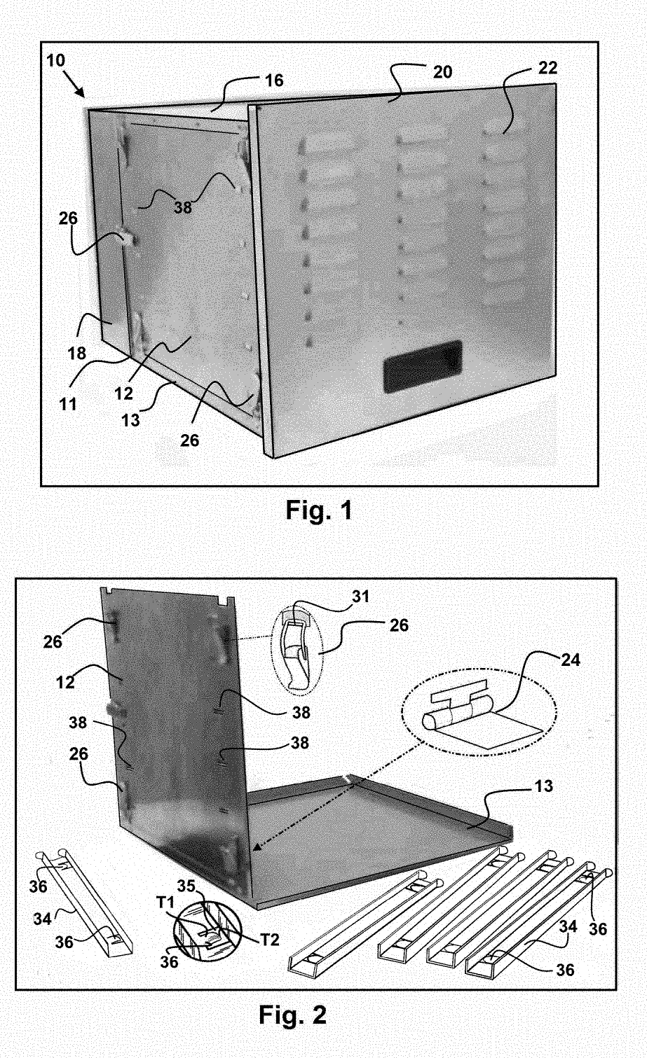

Now referring to drawings in FIGS. 1-8, wherein similar components are identified by like reference numerals, there is seen in FIG. 1 which as noted, a perspective view of the portable collapsible food dehydrator device 10 herein, in the assembled configuration.

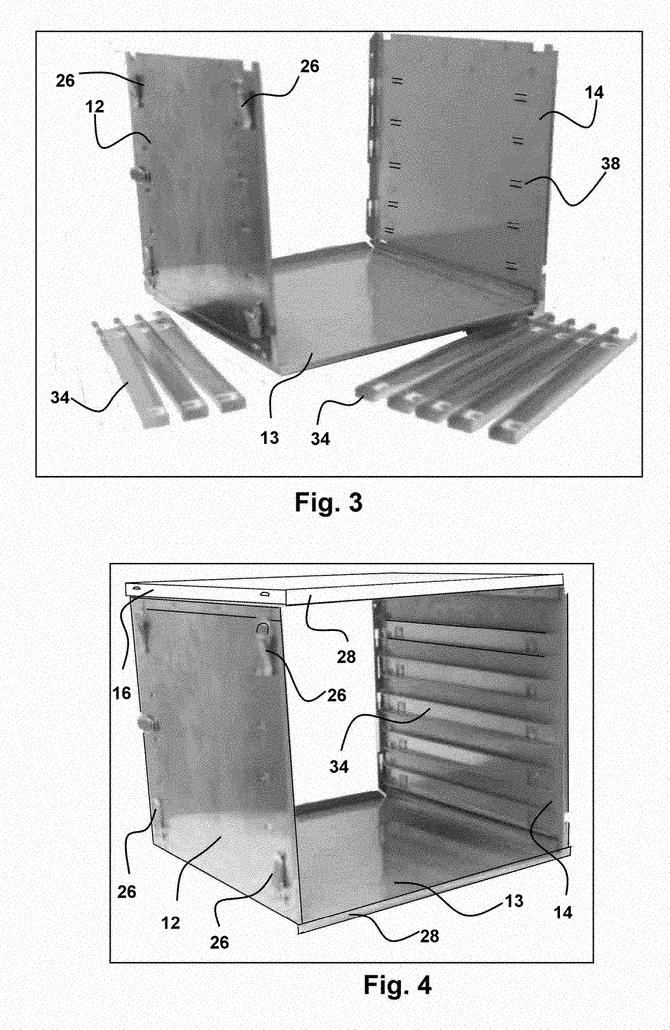

As shown, the device 10 is formed from a first sidewall 12 which is engaged with a bottom wall 13 and has a second sidewall (FIG. 3) also engaged with the bottom wall 13. A top wall 16 engages with upper ends of the two sidewalls 12 and 14, and a fan housing 18 which also forms a rear wall and engages to the formed housing 11. The formed housing 11, has a removable front wall 20 providing access to an interior cavity of the formed housing where racks are mounted on tracks 34 engaged to the interior surfaces of opposing sidewalls 12 and 14.

It is preferred as shown in FIG. 2, that the first sidewall 12 engage with the bottom wall 13, using a pivot component such as a hinge 24 to form a permanent rotational engagement between the bottom of the first sidewall 12, and one side of the bottom wall 13. This is preferred as it has been shown in experimentation to provide a sturdy engagement and also provide the user with a much easier assembly since the first sidewall 12 is already engaged to the bottom wall 13 and is rotated away from the bottom wall 13 in a fixed engagement at the start of assembly.

In all modes of the device 10 herein, the sidewalls 12 and 14 and fan housing 18 forming the rear wall, are operatively engaged to the formed device 10 using separable complimentary fasteners connected between each component. While such might be screws, or pins, or straps, or other separable fasteners, the depicted tensional fasteners 26 are the current preferred mode for fastening. This is because such tensional fasteners 26, connected between two components of the device 10, impart a significant bias or compression of the connected components toward each other, to fix them in position. This tensioned engagement was found, during experimentation of modes for assembly of the device 10, to form a significantly enhanced cabinet 11, which maintains its shape, and does not tend to have any of the sidewalls 12 and 14 or top wall 16, translate or diagonally move, relative to the bottom wall 13, once the cabinet 11 of the device 10 is assembled.

Screws and clips it was found, while holding the components of the cabinet 11 together, did not provide this enhanced structural maintenance of the formed cabinet 11, as the sidewalls 12 and 14 tended to lean in their respective engagements between the top wall 16 and bottom wall 13. Consequently, employment of tensional fasteners 26 as the complimentary fasteners to engage the walls and fan housing, are preferred to yield this enhanced structural rigidity.

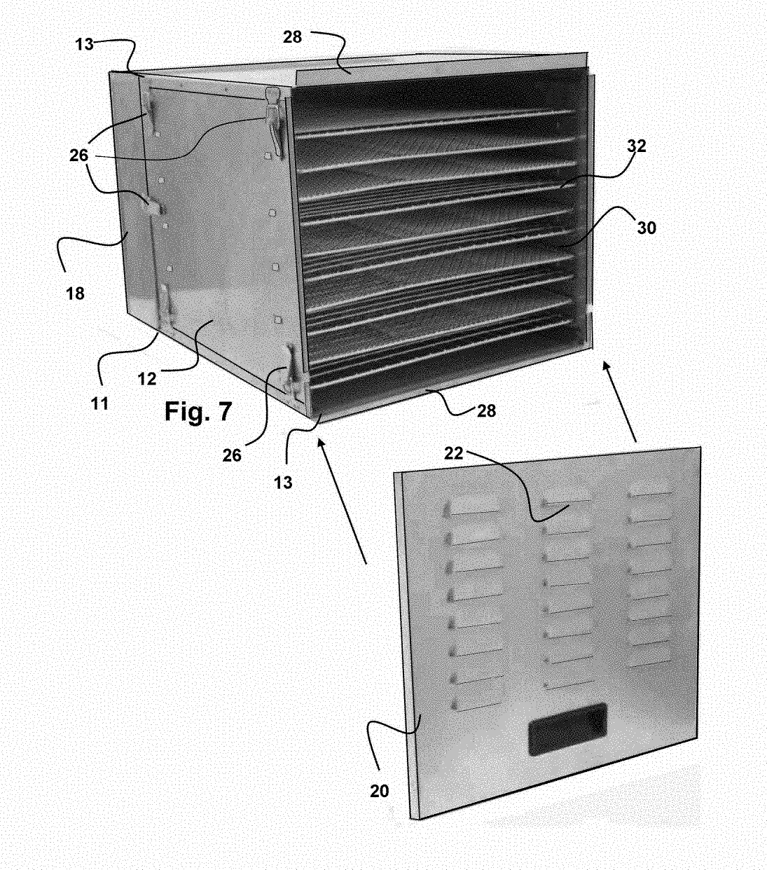

As also shown in FIG. 1, the front wall 20 is removably engaged to the front of the formed housing 11 using ledges 28 (FIGS. 2 and 7) which project from the top wall 16 and may project from the bottom wall 13, to hold the front wall 20 in registered positioning on the front of the cabinet 11. This registered positioning is important as it positions passages 22 communicating through the front wall 20, to communicate air therethrough, and through flow paths 30 running in-between racks 32 (FIG. 7) with the device 10 assembled. Thus, air pulled through the housing 11 will pass through the passages 22, along the flowpaths 30 between the racks 32, and exhaust from the fan housing 18 at the rear of the cabinet 11.

As noted, in FIG. 2 is shown a perspective view of the bottom wall 13 which is hinged in engagement to the first sidewall 12 using the shown hinge 24 to yield the rotational engagement between the two. Also shown in an enlarged window, is the preferred tensional fastener 26, which type is well known, and has a hoop shaped member 27 which impart tension to the connection when the latch 29 of the fastener is rotated with the hoop shaped member 27 engaged over a projection 31 mounted on the part to be engaged. The tension from each of these tensional fasteners 26 is preferred over other types of fasteners such as screws and nuts, since as noted it yields increased structural rigidity to the assembled cabinet 11.

Also shown in FIG. 2, are the plurality of shelf tracks 34 which in all modes are preferably formed in a C-shaped configuration. The shelf tracks 34 are removably engageable in registered opposing positions on interior surfaces of both the first sidewall 12 and second sidewall 14. Mating fasteners on both the sidewalls 12 and 14 and the tracks 34 provide this removable engagement.

Currently especially preferred for the mating fasteners are the employment of tension imparting tabs 36 on the tracks 34 which are positioned to engage with slots 38 formed through the first and second sidewalls 12 and 14. Preferably the tabs 36 have planar portion T1 which extends between a slightly angled or curved portion T2 at a distal and a connection on a first end with the track 34. An opening 35, communicating through the wall forming the C-shaped track 34, surrounds the curved portion T2 of each tab 36 allowing the curved portion T2 at the distal end of the tab 36 to project through.

Each of the tabs 36 on each of the C-shaped tracks 34 is positioned to register with and engage into opposing slots 38 formed through the opposing sidewalls 12. Upon sliding each tab 36 into each mating registered slot 38, the curved portion T2 at the distal end of each tab 36, allows for easier initial sliding through each slot 38, and then the first portion T1 engages into the slot 38. The first portion T1 engagement imparts a tension from a slight bending of the tab 36 as the first portion T1, slides into the slot 38.

This configuration is particularly preferred because it forms a compressive engagement of each of the C-shaped tracks 34 against the interior surface of each opposing sidewall 12. The C-shaped tracks 34 so compressibly but removably engaged against the interior surfaces of the opposing sidewalls 12 and 14, thereby form reinforced pillars or beams which strengthen the sidewalls 12 and 14.

The slots 38 in each sidewall 12, so positioned to register with and engage each of the pair of tabs 36 on each of the tracks 34, thereby aligns the tracks 34 in compressive mounts on the interior surface of each of the opposing sidewalls 12 and 14 such as shown in FIG. 7. While other means to engage the tracks 34 were tried and can be used such as screw fasteners and holes, it was found that the engagement of compressive engagement of the C-shaped tracks 34, with the curved tabs 36 formed a sturdier reinforcement of the sidewalls 12, and also alleviated the problem of lost fasteners during multiple assembly and disassembly actions. The compressed engagement also helped dampen noise and vibration which was particularly preferred.

Also, while the tracks 34 can be L-shaped to support the shelves, and such was tried during experimentation, it was found that the employment of the C-shaped tracks 34 provided a much sturdier assembly as the L-shaped versions tended to slide and rotate more once engaged.

In FIG. 3, is shown an example of a step in assembly of the food dehydrator device 10, subsequent to the rotation of the first sidewall 12 upward from the bottom wall 13 in FIG. 2. As shown, the second sidewall 14 is engaged with the bottom wall 13 and positions the slots 38, ready for engagement with the tabs 36 of the tracks 34 to engagement in registered positioning. Also depicted are the positioning of the top wall 16 having a ledge 28 to engage with the top of the front wall 22, where gravity will hold the front wall 20 in operative positioning during use.

In FIG. 4 is shown the components of the food dehydrator device 10 during assembly, showing how the top wall 16 may be engaged with both sidewalls 12 and 14, by the engagement of tensioning fasteners 26 on one component with projections 31 on the other. Also depicted are the tabs 36 of each track 34 engaged with slots 38 in the sidewalls 12 and 14, and ready for insertion of food racks 32.

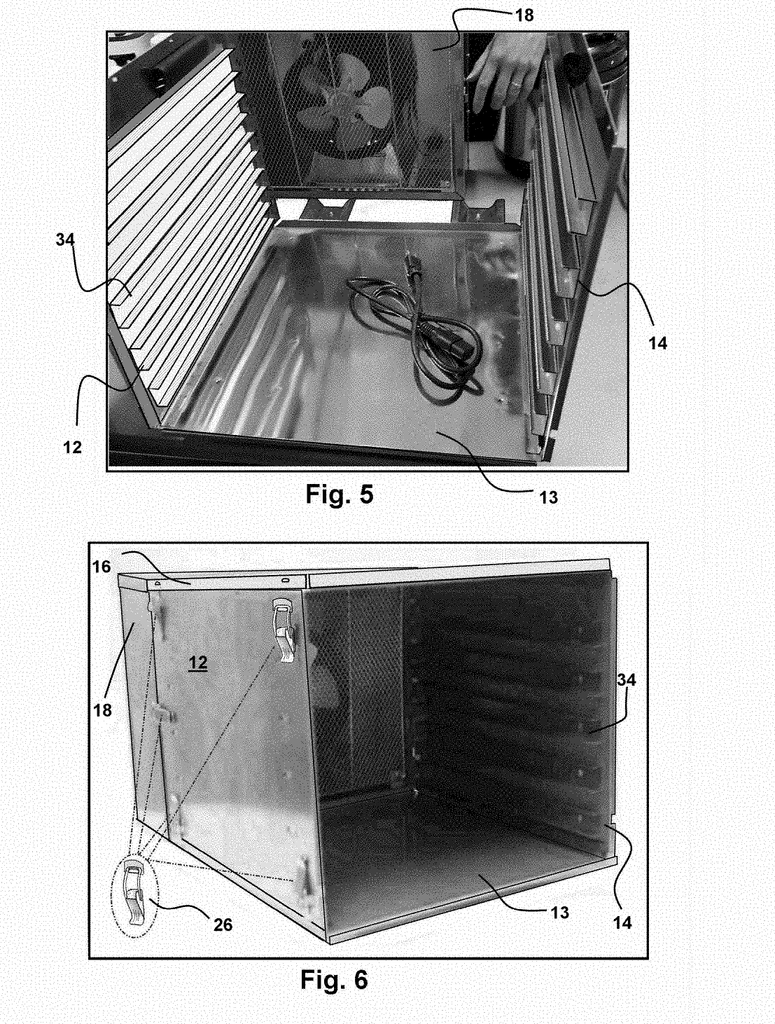

FIG. 5, shows the fan housing 18 being positioned for attachment as a rear wall of the cabinet 11, using the tensional fasteners 26 shown in FIG. 6. Also shown are the bottom wall 13, sidewalls 12 and 14, and opposing tracks 34 operatively engaged on opposing interior surfaces on opposite sides of the interior cavity.

In FIG. 6 can be seen, the fan housing 18 engaged with the cabinet 11 of the device 10 herein which is formed by the sidewalls 12 and 14, top wall 16 and bottom wall 13 all operatively engaged with mating fasteners such as the shown and preferred tensional fasteners 26 which impart rigidity to the formed structure. Such rigidity as noted is particularly preferred due to the weight of the food and racks 32 engaged during use, to maintain the sidewalls 12 and 14 substantially perpendicular to the bottom wall 13 and prevent tipping which would through the cabinet 11 out of square.

FIG. 7 as noted, is a perspective view of the device 10 as in FIG. 6. As shown, the front wall 20 which is removably engageable with mating engagement such as ledges 28 projecting from one or both of the top wall 16 and bottom wall 13 of the cabinet 11. Also shown are the air passages 22 in registered positioning to direct air through flowpaths 30 in-between each rack 32 shown mounted in sidewall-engaged tracks 34.

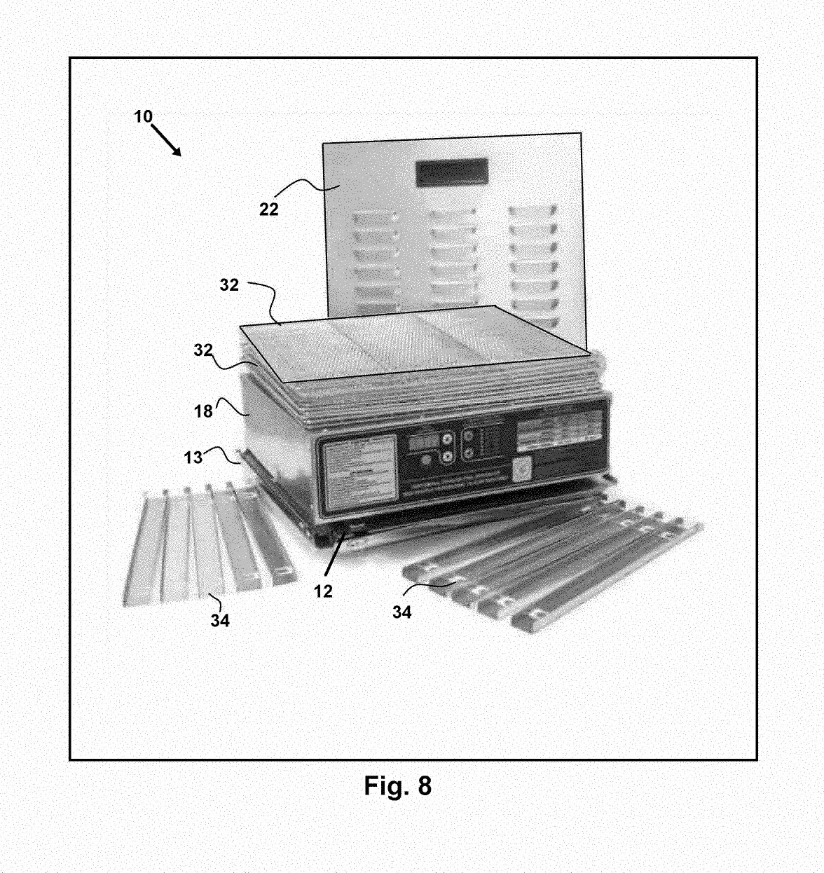

Finally, FIG. 8, shows the utility of the device 10 in that it may be disassembled, and the sidewalls 12 and 14, top wall 16, bottom wall 13, front wall 20, and fan housing 18, along with the racks 32 and tracks 34, may be stacked in a footprint the size of one sidewall 12, in compact configuration for storage and transport.

While all of the fundamental characteristics and features of the food dehydrator device 10 herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful device and system herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the invention as defined by the following claims.

What is claimed is:

1. A collapsible food dehydrator apparatus, comprising:
a first sidewall having an exterior surface opposite an interior surface;
a second sidewall having an exterior surface opposite an interior surface;
a bottom wall;
a top wall;
fasteners forming a removable engagement between, a first edge of said first sidewall to said top wall, a second edge of said first sidewall to said bottom wall, a first edge of said second sidewall to said top wall, and a second edge of said second sidewall to said bottom wall, thereby forming a cabinet having an interior cavity;
a plurality of tracks engageable with track fasteners to opposing positions on a said respective interior surface of each of said first sidewall and said second sidewall thereby forming a plurality of opposing pairs of tracks;
a plurality of shelves each being slidably engageable with one of said plurality of opposing pairs of tracks;
a front wall removably engageable with said cabinet; and
a fan housing having an electric fan, said fan housing being removably engageable with said cabinet on an opposite side of said interior cavity from said front wall.

2. The collapsible food dehydrator apparatus of claim 1, additionally comprising:
hinges rotationally connecting said second edge of said first sidewall to said bottom wall.

3. The collapsible food dehydrator apparatus of claim 1, additionally comprising:
said fasteners being tension imparting fasteners forming a compressive said removable engagement.

4. The collapsible food dehydrator apparatus of claim 2, additionally comprising:
hinges rotationally connecting said second edge of said first sidewall to said bottom wall.

5. The collapsible food dehydrator apparatus of claim 1, wherein said track fasteners comprise:
pairs of tabs extending from one side of each said track; and
pairs of slots communicating through each of said first wall and said second wall, each slot of each of said pairs of slots forming a sliding engagement a said tab.

6. The collapsible food dehydrator apparatus of claim 2, wherein said track fasteners comprise:
pairs of tabs extending from one side of each said track; and
pairs of slots communicating through each of said first wall and said second wall, each slot of each of said pairs of slots forming a sliding engagement a said tab.

7. The collapsible food dehydrator apparatus of claim 3, wherein said track fasteners comprise:
pairs of tabs extending from one side of each said track; and
pairs of slots communicating through each of said first wall and said second wall, each slot of each of said pairs of slots forming a sliding engagement with a said tab.

8. The collapsible food dehydrator apparatus of claim 4, wherein said track fasteners comprise:
pairs of tabs extending from one side of each said track; and
pairs of slots communicating through each of said first wall and said second wall, each slot of each of said pairs of slots forming a sliding engagement with a said tab.

9. The collapsible food dehydrator apparatus of claim 5, wherein each tab in each of said pairs of tabs has a planar first end connected to said track and extends to a curved distal end and a flexing of said tab during engagement of each said tab with each said slot forms a compressive engagement of said track with a respective one of said first sidewall or second sidewall.

10. The collapsible food dehydrator apparatus of claim 6, wherein each tab in each of said pairs of tabs has a planar first end connected to said track and extends to a curved distal end and a flexing of said tab during engagement of each said tab with each said slot forms a compressive engagement of said track with a respective one of said first sidewall or second sidewall.

11. The collapsible food dehydrator apparatus of claim 7, wherein each tab in each of said pairs of tabs has a planar first end connected to said track and extends to a curved distal end and a flexing of said tab during engagement of each said tab with each said slot forms a compressive engagement of said track with a respective one of said first sidewall or second sidewall.

12. The collapsible food dehydrator apparatus of claim 8, wherein each tab in each of said pairs of tabs has a planar first end connected to said track and extends to a curved distal end and a flexing of said tab during engagement of each said tab with each said slot forms a compressive engagement of said track with a respective one of said first sidewall or second sidewall.

13. The collapsible food dehydrator apparatus of claim 9 wherein said track is C-shaped.

14. The collapsible food dehydrator apparatus of claim 10 wherein said track is C-shaped.

15. The collapsible food dehydrator apparatus of claim 11 wherein said track is C-shaped.

16. The collapsible food dehydrator apparatus of claim 12 wherein said track is C-shaped.
